(19) United States
(12) Patent Application Publication
(10) Pub. No.: US 2009/0115788 A1
(43) Pub. Date: May 7, 2009

(54) Mobile computer with auxiliary display on a secondary device

(76) Inventors: James Timothy Black, Austin, TX (US); Terry Lynn Cole, Austin, TX (US); Mario A. Rivas, Austin, TX (US)

Correspondence Address: HAMILTON & TERRILE, LLP - AMD, P.O. BOX 203518, AUSTIN, TX, 78720, US

(21) Appl. No.: 11/935,772

(22) Filed: Nov. 6, 2007

(51) Int. Cl. G06F 13/14

(52) U.S. Cl. 345/520

(57) ABSTRACT

A system and method is disclosed for wirelessly communicating displayable information for display on an auxiliary display device. A primary display device comprising a first display and a first wireless modem generates displayable information. The availability of one or more auxiliary display devices and information is collected to determine which of the auxiliary display devices are supported by the primary display device. The power state of the primary display device is monitored. If it is operating in a full power state, a full auxiliary display output mode is maintained allowing all, or a subset, of the displayable information generated by the first display device to be displayed on supported auxiliary display devices. If it is operating in a low or off power state, a subset auxiliary display output mode is activated and a predetermined subset of the displayable information is displayed on the supported auxiliary display devices.

### BACKGROUND OF THE INVENTION

1. Field of the Invention

Embodiments of the invention relate generally to information processing and communication systems. More specifically, embodiments of the invention provide a system and method for wirelessly communicating displayable information for display on an auxiliary display device.

2. Description of the Related Art

Advances in microprocessor design and manufacturing have led to the evolution of powerful computing platforms with small form factors, modest power consumption, and low heat dissipation. These platforms have been adopted for use in a wide variety of wirelessly-enabled mobile devices that include cell phones, smartphones, personal digital assistants (PDAs), tablet PCs, and laptop computers. While many of these devices share similar operational, processing, display and communications capabilities, no single device addresses all needs.

As a result, there has been a steady proliferation of mobile, wirelessly-enabled devices, with the user often carrying multiple devices. For example, it has become common for a mobile user to travel with a laptop computer, a personal digital assistant (PDA), a cell phone, and an audio/video (A/V) media player. Each of these may be optimized to serve a specific purpose, with resulting limitations in the size, resolution or capabilities of their respective displays. For example, many personal digital assistants (PDAs) possess significant processing power, but their reduced form factors restrict the size of their display screens. There are times when a mobile user would prefer to have expanded display capabilities or a larger screen. In some cases, the mobile device includes an external display port, allowing it to be physically attached to another display device such as a flat panel display or liquid crystal diode (LCD) projector.

However, even when physical connections are used, connectivity is generally limited to a single display device and the proper physical cable or adapters must be available. In other cases it is more difficult, or even impossible, to physically connect the mobile device to other display devices. Users increasingly want to quickly and easily display the output of their mobile devices on a display that is best suited for a given set of circumstances. While it would be advantageous to use the wireless connectivity of these devices to communicate the displayable information they generate for display on an auxiliary device, this ability does not currently exist.

### SUMMARY OF THE INVENTION

The present invention includes, but is not limited to, a system and method for wirelessly communicating displayable information for display on an auxiliary display device. In various embodiments, a primary display device operable to generate displayable information comprises a first display and a first wireless modem. In one embodiment, a first display connectivity manager is implemented in the primary display device. In another embodiment, a first display connectivity manager is implemented in the first wireless modem.

In these and other embodiments, the operational status and display connectivity capabilities of the primary display device are determined. The primary display device then makes a connection to a wireless network. The wireless network may comprise a wireless wide area network (WWAN), a wireless local area network (WLAN), a personal area network (PAN), or other wireless communication technologies. Once a wireless connection is established, the availability of one or more auxiliary display devices is determined. Each auxiliary display device comprises a second display and a second wireless modem. In one embodiment, a second display connectivity manager is implemented in the auxiliary display device. In another embodiment, a second display connectivity manager is implemented in the second wireless modem.

A wireless connection is then established between the primary display device and any detected auxiliary display devices. Information about each of the auxiliary display devices is collected to determine which are supported by the primary display device. The power state of the primary display device is monitored to determine if it is operating in a full, low or off power state. If it is operating in a full power state, then a full auxiliary display output mode is activated. The primary display device user then decides whether to display all of the displayable information output generated by the primary display device, or a subset. The displayable information output is then displayed on the supported auxiliary display devices. If the primary display device is operating in a low, or off power state, then a subset auxiliary display output mode is activated and a predetermined subset of the displayable information is displayed on the supported auxiliary display devices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating a display connectivity manager as implemented with an information processing system (IPS) in accordance with an embodiment of the invention;

FIG. 2 is a generalized block diagram illustrating a display connectivity manager as implemented with a wireless modem in accordance with an embodiment of the invention;

FIG. 3 is a simplified block diagram illustrating a plurality of wireless modem implementations connecting an IPS to a plurality of networks in accordance with an embodiment of the invention;

FIG. 4 is a simplified block diagram illustrating an auxiliary display device comprising an embedded wireless modem as implemented in accordance with an embodiment of the invention;

FIG. 5 is a simplified block diagram illustrating an auxiliary display device comprising a physically coupled wireless modem as implemented in accordance with an embodiment of the invention;

FIG. 6 is a simplified block diagram illustrating an auxiliary display device comprising a wirelessly connected wireless modem as implemented in accordance with an embodiment of the invention;

FIG. 7 is a simplified block diagram illustrating an auxiliary display device comprising a physically coupled wireless modem as implemented in accordance with an embodiment of the invention;

FIG. 8 is a simplified block diagram illustrating the wireless communication of display information from a primary display device to a plurality of auxiliary display devices in accordance with an embodiment of the invention; and

FIG. 9a-d are a generalized flowchart of a display connectivity manager as implemented in accordance with an embodiment of the invention.

### DETAILED DESCRIPTION

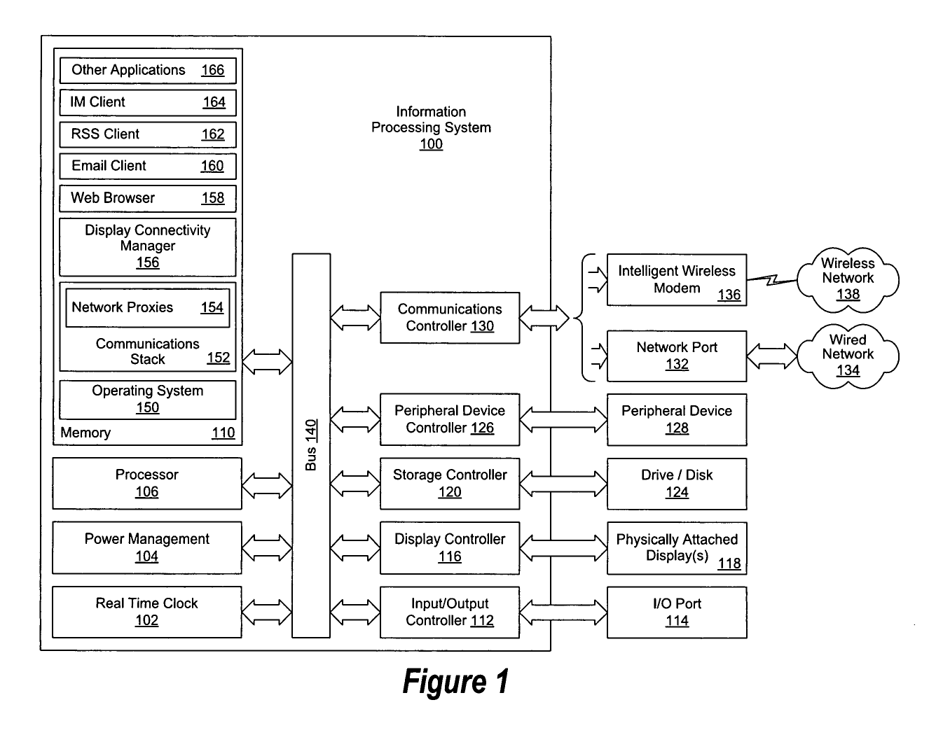

A system and method is disclosed for wirelessly communicating displayable information generated by a first display device for display on an auxiliary display device. FIG. 1 is a generalized block diagram illustrating a display connectivity manager as implemented with an information processing system 100 in accordance with an embodiment of the invention. Information processing system 100 comprises a real-time clock 102, a power management module 104, a processor 106, and memory 110, all physically coupled via bus 140. In different embodiments, memory 110 comprises volatile random access memory (RAM), non-volatile read-only memory (ROM), non-volatile flash memory, or any combination thereof. In one embodiment, memory 110 also comprises operating system 150, communications stack 152, further comprising network proxies 154, and display connectivity manager 156. Memory 110 further comprises Web browser 158, email client 160, real simple syndication (RSS) client 162, instant messaging (IM) client 164, and other applications 166.

Also physically coupled to bus 140 is an input/out (I/O) controller 112, further coupled to a plurality of I/O ports 114. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Display controller 116 is likewise physically coupled to bus 140 and further physically coupled to one or more displays 118. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA) or cell phone. Likewise, physically coupled to bus 140 is storage controller 120 which is further coupled to mass storage devices such as a tape drive or hard disk 124. Peripheral device controller 126 is also physically coupled to bus 140 and further coupled to peripheral device 128, such as a redundant array of independent disk (RAID) array or a storage area network (SAN).

In one embodiment, communications controller 130 is physically coupled to bus 140 and is further coupled to network port 132, which in turn couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to network 134. In these embodiments, network 134 may comprise the public switched telephone network (PSTN), the public Internet, a corporate intranet, a secure private network, or any combination of telecommunication technologies and protocols operable to establish a network connection for the exchange of information.

In another embodiment, communications controller 130 is likewise physically coupled to bus 140 and is further coupled to an intelligent wireless modem 136, which in turn couples the information processing system 100 to one or more wireless networks 138. In one embodiment, wireless network 138 comprises a personal area network (PAN), based on technologies such as Bluetooth or Ultra Wideband (UWB). In another embodiment, wireless network 138 comprises a wireless local area network (WLAN), based on variations of the IEEE 802.11 specification, often referred to as WiFi. In yet another embodiment, wireless network 138 comprises a wireless wide area network (WWAN) based on an industry standard including two and a half generation (2.5G) wireless technologies such as global system for mobile communications (GPRS) and enhanced data rates for GSM evolution (EDGE). In other embodiments, wireless network 138 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

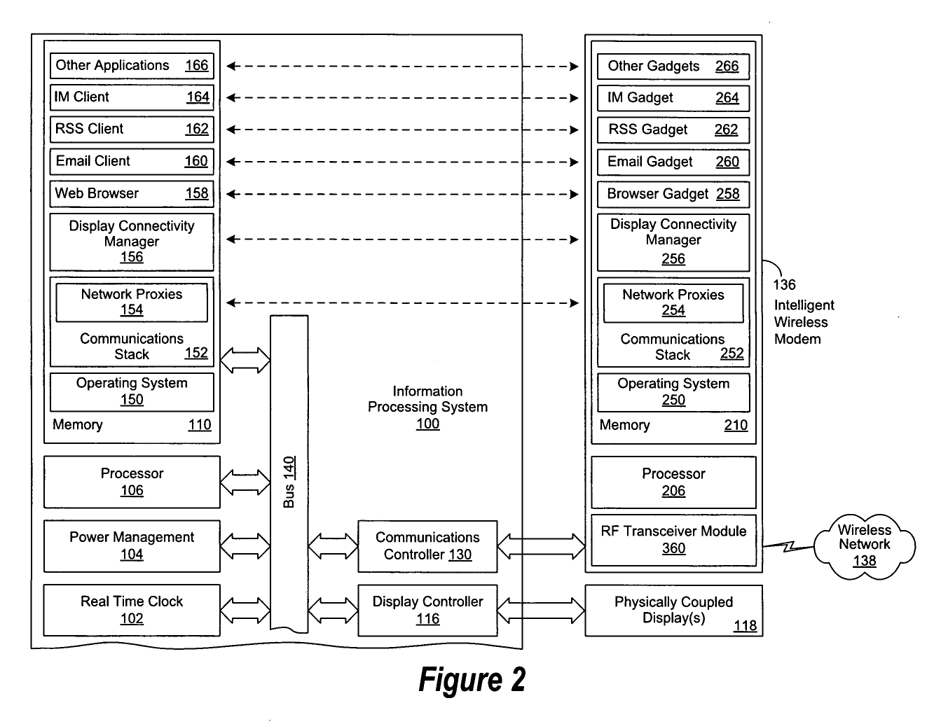

FIG. 2 is a generalized block diagram illustrating a display connectivity manager 256 as implemented with an intelligent wireless modem 136 in accordance with an embodiment of the invention. Information processing system (IPS) 100 comprises a real-time clock 102, a power management module 104, a processor 106 and memory 110, all physically coupled via bus 140. In different embodiments, memory 110 comprises volatile random access memory (RAM), non-volatile read-only memory (ROM), non-volatile flash memory, or any combination thereof. In one embodiment, memory 110 also comprises operating system 150, communications stack 152, further comprising network proxies 154, and display connectivity manager 156. Memory 110 further comprises Web browser 158, email client 160, real simple syndication (RSS) client 162, instant messaging (IM) client 164, and other applications 166.

Display controller 116 is likewise physically coupled to bus 140 and further physically coupled to one or more displays 118. In one embodiment, communications controller 130 is physically coupled to bus 140 and is further coupled to an intelligent wireless modem 136 which in turn couples the IPS 100 to one or more wireless networks 138. As described in greater detail herein, wireless network 138 may comprise a wireless wide area network (WWAN), a wireless local area network (WLAN), a personal area network (PAN), or other combinations of wireless communication technologies. In this embodiment, the intelligent wireless modem comprises a radio frequency (RF) transceiver module 360, a processor 206, and memory 210.

In different embodiments, memory 210 comprises volatile random access memory (RAM), non-volatile read-only memory (ROM), non-volatile flash memory, or any combination thereof. In one embodiment, memory 210 also comprises operating system 250, communications stack 252, further comprising network proxies 254, and display connectivity manager 256. The operational capabilities of communications stack 252, network proxies 254, and display connectivity manager 256 correspond to their respective entities 152, 154, 156 implemented in the IPS 100. In one embodiment, the communications stack 252, network proxies 254, and display connectivity manager 256 are operable to perform their respective operations when the IPS 100 is in an off or low power state.

Memory 210 further comprises Web browser gadget 258, email client gadget 260, real simple syndication (RSS) client gadget 262, instant messaging (IM) client gadget 264, and other application gadgets 266. The functionality of these gadgets, which are typically implemented as light-weight single-purpose applications, correspond to their respective entities 158, 160, 162, 164, 166 as implemented in the memory 110 of IPS 100. In these implementation, the gadget's 258, 260, 262, 264, 266 output is displayed on an auxiliary external display, such as on the outside of a laptop computer. As a result, they enable access to information and media even when the IPS is in an off or low power state. In different embodiments, displayable information can also be displayed on other network-connected devices via WWAN, WLAN, and PAN connectivity options, regardless of the form factor of their respective displays.

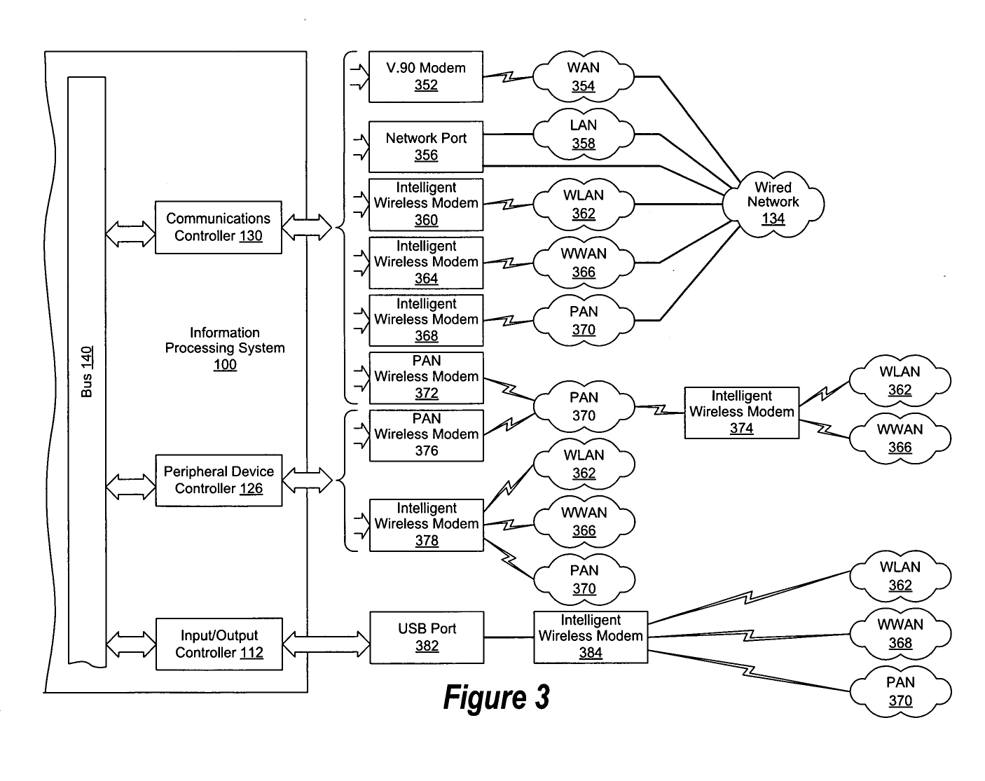

FIG. 3 is a simplified block diagram illustrating a plurality of wireless modem implementations 360, 364, 368, 374, 378, 382 connecting an information processing system (IPS) 100 to a plurality of networks 362, 366, 370 in accordance with an embodiment of the invention. In various embodiments, communications controller 130, peripheral device controller 126, and input/output (I/O) controller 112 are physically coupled to bus 140. In one embodiment, communications controller 130 is further physically coupled to V.90 modem 352, which is operable to provide connectivity to a wide area network (WAN) 354, such as the public switched telephone network (PSTN) or an X.25 packet switched network.

In another embodiment, communications controller 130 is further physically coupled to a network port 356, which is operable to provide connectivity to a local area network (LAN) 358, such as a LAN based on the Ethernet standard. In other embodiments, network port 356 may comprise a digital subscriber line (DSL) modem, cable modem, or other broadband communications system operable to connect the information processing system 100 to wired network 134. In these embodiments, wired network 134 may comprise the public switched telephone network (PSTN), the public Internet, a corporate intranet, a secure private network, or any combination of telecommunication technologies and protocols operable to establish a network connection for the exchange of information.

In a different embodiment, communications controller 130 is further physically coupled to an intelligent wireless modem 360, which is operable to provide connectivity to a wireless local area network (WLAN) 362, such as a WLAN based on variations of the IEEE 802.11 specification, commonly referred to as WiFi. In another embodiment, communications controller 130 is further physically coupled to an intelligent wireless modem 364, which is operable to provide connectivity to a wireless wide area network (WWAN) 366. In these and other embodiments, WWAN 366 is based on an industry standard including two and a half generation (2.5G) wireless technologies such as global system for mobile communications (GSM), and its corresponding data communications protocols known as general packet radio service (GPRS) and enhanced data rates for GSM evolution (EDGE). In still other embodiments, WWAN 366 is based on existing third generation (3G) wireless technologies including universal mobile telecommunications system (UMTS) and wideband code division multiple access (W-CDMA). In yet other embodiments, WWAN 366 is based on the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

In still another embodiment, communications controller 130 is further physically coupled to an intelligent wireless modem 368, which is operable to provide connectivity to a wireless personal area network (PAN) 370. In one embodiment, PAN 370 is based on the Bluetooth standard. In another embodiment, PAN 370 is based on Ultra Wideband (UWB) technology. In a different embodiment, communications controller 130 is further physically coupled to a PAN wireless modem 372, which provides connectivity to PAN 370. In turn, PAN 370 provides connectivity to intelligent wireless modem 374, which is operable to provide further connectivity to WWAN 366 and to WLAN 362.

In one embodiment, peripheral device controller 126 is further physically connected, such as through a PCMCIA or ExpressCard slot, to PAN wireless modem 376, which provides connectivity to PAN 370. In turn, PAN 370 provides connectivity to intelligent wireless modem 374, which is operable to provide further connectivity to WWAN 366 and to WLAN 362. In a different embodiment, peripheral device controller 126 is further physically connected, such as through a PCMCIA, PC Card, or ExpressCard slot, to intelligent wireless modem 378. In turn, intelligent wireless modem 378 provides connectivity to WLAN 362, WWAN 366, and PAN 370.

In another embodiment, I/O controller 112 is further physically coupled to a USB port 382, which in turn is physically coupled to wireless modem 384, which is operable to provide connectivity to WLAN 362, WWAN 366, and PAN 370. In still another embodiment, I/O controller 112 is physically coupled to wireless modem 382 through an IEEE 1394 (Firewire) connection. In each of these embodiments, WAN 354, LAN 358, WLAN 362, WWAN 366, and PAN 370 are operable to be connected to wired network 134. As described in greater detail herein, wired network 134 may comprise any combination of telecommunication technologies and protocols operable to establish a network connection for the exchange of information, including display control information and displayable information.

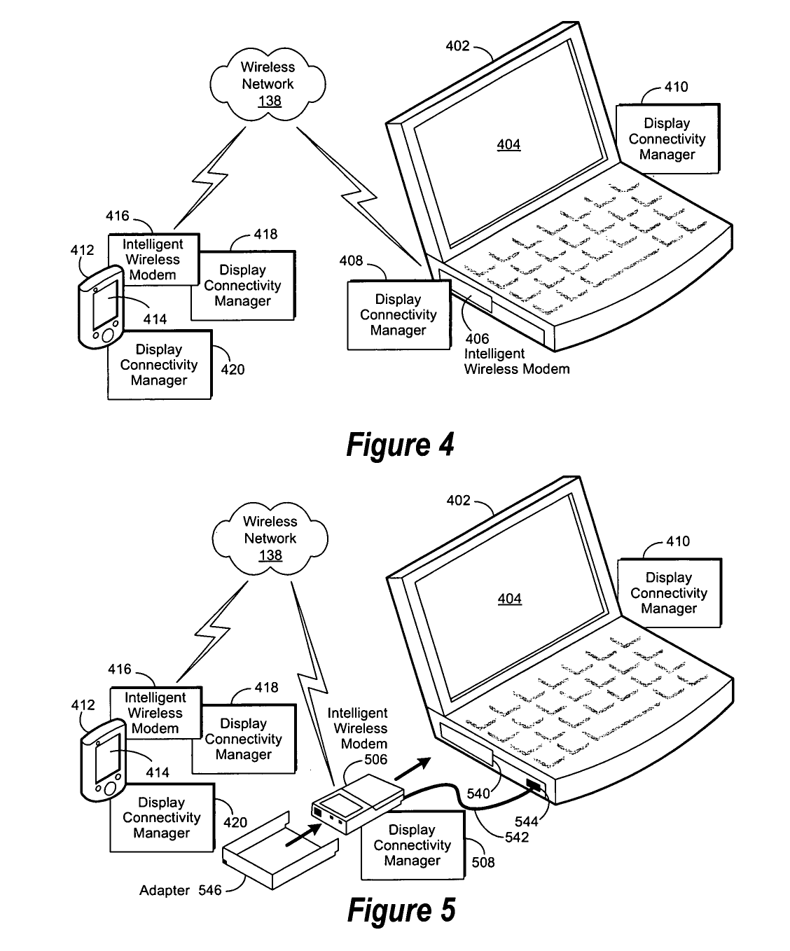

FIG. 4 is a simplified block diagram illustrating an auxiliary display device 402 comprising an embedded wireless modem 406 as implemented in accordance with an embodiment of the invention. In this embodiment, a primary display device 412, such as a personal digital assistant (PDA), comprises a first display 414 and a first intelligent wireless modem 416. In one embodiment, a first display connectivity manager 420 is implemented in the primary display device 412. In another embodiment, a second display connectivity manager 418 is implemented in the intelligent wireless modem 416. An auxiliary display device 402, such as a laptop computer, comprises a second display 404 and a second intelligent wireless modem 406, which is embedded. In one embodiment, a third display connectivity manager 410 is implemented in the auxiliary display device 402. In another embodiment, a fourth display connectivity manager 408 is implemented in the auxiliary display device's embedded, intelligent wireless modem 406.

In various embodiments, the operational status and display connectivity capabilities of the primary display device 412 are determined. A wireless connection is then established between the primary display device 412 and the wireless network 138. As described in greater detail herein, the wireless network 138 may comprise a wireless wide area network (WWAN), a wireless local area network (WLAN), a personal area network (PAN), or other combinations of wireless communication technologies. In one embodiment, the primary display device 412 is implemented with an intelligent wireless modem 414 that supports connectivity to multiple wireless networks. As an example, a mobile device user may be in a venue where both WWAN and WLAN connectivity is available. As a result, the user has a choice of connecting to either the WWAN or the WLAN. It will be appreciated that such connectivity options often present trade-offs. For example, connectivity to an EDGE WWAN may offer broader network coverage but limited bandwidth. Conversely, connectivity to an 802.11 WLAN may provide higher bandwidth at the expense of limited network range and coverage.

In these and other embodiments, one of the display connectivity managers 416, 418 are selected to perform auxiliary display device autodetection operations to detect the presence and availability of the auxiliary display device 402. In one embodiment, the primary display device 412 is operating in a full power state and the first display connectivity manager 420 is used to perform the auxiliary display device autodetection operations. In another embodiment, the primary display device 412 is operating in an off or low power state and the second display connectivity manager 418 is used to perform the auxiliary display device autodetection operations. In yet another embodiment, the presence and availability of the auxiliary display device 402 is known and auxiliary display device autodetection operations are not required.

In different embodiments, one of the display connectivity managers 416, 418 is selected to establish a connection between the intelligent wireless modem 414 and the intelligent wireless modem 406 embedded in the auxiliary display device 402. Once the connection is established, the selected display connectivity manager 416, 418 collects information about the available auxiliary display device 402 from its corresponding third or fourth display connectivity manager 408, 410. Once information about the auxiliary display device 402 is collected, a determination is made whether display 404 of the available auxiliary display device 402 is supported by either the first or second display connectivity manager 418, 420. In one embodiment, support for the display 404 of auxiliary display device 402 is determined by the implementation of the display connectivity manager 420 on the primary display device 412. In another embodiment, support for the available auxiliary display device 402 is determined by the implementation of the display connectivity manager 418 on the intelligent wireless modem 416 coupled to the primary display device 412.

If it is determined that the auxiliary display device 402 is supported, then predetermined display control information is exchanged between either the first or second display connectivity managers 418, 420 and either the third or fourth display connectivity managers 408, 410. The exchanged display control information is then used to establish and maintain a session for the transmission of predetermined displayable information generated by the primary display device 412 for display on the display 404 of auxiliary display device 402. In one embodiment, a full auxiliary display output mode is activated when the primary display device 412 is operating in a full power state. In this mode, all displayable information generated by applications running on primary display device 412 is displayed on the display 404 of the auxiliary display device 402. In another embodiment, a predetermined subset of displayable information generated by applications running on primary display device 412 is selectively displayed on the display 404 of the auxiliary display device 402. In yet another embodiment, a subset auxiliary display output mode is activated when the primary display device 412 is in a low or offpower state. In this mode, a predetermined subset of displayable information generated by gadget applications running on the intelligent wireless modem 416 connected to the primary display device 412 is displayed on the display 404 of the auxiliary display device 402.

FIG. 5 is a simplified block diagram illustrating an auxiliary display device 402 comprising a physically coupled wireless modem 506 as implemented in accordance with an embodiment of the invention. In this embodiment, a primary display device 412, such as a personal digital assistant (PDA), comprises a first display 414 and a first intelligent wireless modem 416. In one embodiment, a first display connectivity manager 420 is implemented in the primary display device 412. In another embodiment, a second display connectivity manager 418 is implemented in the intelligent wireless modem 416. An auxiliary display device 402, such as a laptop computer, comprises a second display 404 and a second intelligent wireless modem 506, which is physically coupled. In one embodiment, the physical coupling is through a cable 542, such as a universal serial bus (USB) cable, which couples the intelligent wireless modem 506 to a port 544. In another embodiment, the physical coupling is through a dock 540 that is physically integrated with auxiliary display device 402, such as a PCMCIA or ExpressCard slot. In yet another embodiment, the intelligent wireless modem 506 is physically coupled to the dock 540 through an adapter 546. In one embodiment, a third display connectivity manager 410 is implemented in the auxiliary display device 402. In another embodiment, a fourth display connectivity manager 508 is implemented in the auxiliary display device's embedded, intelligent wireless modem 406.

In various embodiments, the operational status and display connectivity capabilities of the primary display device 412 are determined. A wireless connection is then established between the primary display device 412 and the wireless network 138. In these and other embodiments, one of the display connectivity managers 416, 418 are selected to perform auxiliary display device autodetection operations to detect the presence and availability of the auxiliary display device 402. In one embodiment, the primary display device 412 is operating in a full power state and the first display connectivity manager 420 is used to perform the auxiliary display device autodetection operations. In another embodiment, the primary display device 412 is operating in an off or low power state and the second display connectivity manager 418 is used to perform the auxiliary display device autodetection operations. In yet another embodiment, the presence and availability of the auxiliary display device 402 is known and auxiliary display device autodetection operations are not required.

In different embodiments, one of the display connectivity managers 416, 418 is selected to establish a connection between the intelligent wireless modem 414 and the intelligent wireless modem 406 physically coupled to the auxiliary display device 402. Once the connection is established, the selected display connectivity manager 416, 418 collects information about the available auxiliary display device 402 from its corresponding third or fourth display connectivity manager 508, 410. Once information about the auxiliary display device 402 is collected, a determination is made whether display 404 of the available auxiliary display device 402 is supported by either the first or second display connectivity manager 418, 420. In one embodiment, support for the display 404 of auxiliary display device 402 is determined by the implementation of the display connectivity manager 420 on the primary display device 412. In another embodiment, support for the available auxiliary display device 402 is determined by the implementation of the display connectivity manager 416 on the intelligent wireless modem 416 coupled to the primary display device 412.

If it is determined that the auxiliary display device 402 is supported, then predetermined display control information is exchanged between either the first or second display connectivity managers 418, 420 and either the third or fourth display connectivity managers 508, 410. The exchanged display control information is then used to establish and maintain a session for the transmission of predetermined displayable information generated by the primary display device 412 for display on the display 404 of auxiliary display device 402. In one embodiment, a full auxiliary display output mode is activated when the primary display device 412 is operating in a full power state. In this mode, all displayable information generated by applications running on primary display device 412 is displayed on the display 404 of the auxiliary display device 402. In another embodiment, a predetermined subset of displayable information generated by applications running on primary display device 412 is selectively displayed on the display 404 of the auxiliary display device 402. In yet another embodiment, a subset auxiliary display output mode is activated when the primary display device 412 is in a low or off power state. In this mode, a predetermined subset of displayable information generated by gadget applications running on the intelligent wireless modem 416 connected to the primary display device 412 is displayed on the display 404 of the auxiliary display device 402.

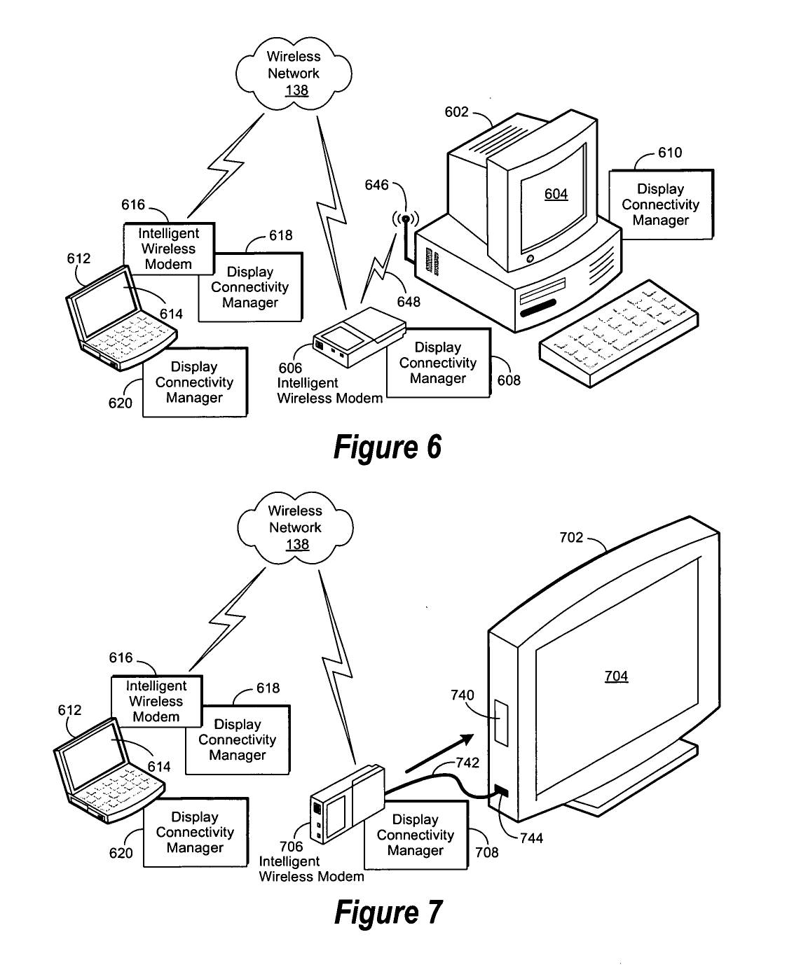

FIG. 6 is a simplified block diagram illustrating an auxiliary display device 602 comprising a wirelessly connected wireless modem 606 as implemented in accordance with an embodiment of the invention. In this embodiment, a primary display device 612, such as a laptop computer, comprises a first display 614 and a first intelligent wireless modem 616. In one embodiment, a first display connectivity manager 620 is implemented in the primary display device 612. In another embodiment, a second display connectivity manager 618 is implemented in the intelligent wireless modem 616.

An auxiliary display device 602, such as a stationary computer, comprises a second display 604 and a second intelligent wireless modem 608, which is wirelessly connected 648. In one embodiment, the wireless connection is through a personal area network (PAN) connection 648 between the intelligent wireless modem 608 and a PAN modem 646 implemented in the auxiliary display device 602. In one embodiment, a third display connectivity manager 610 is implemented in the auxiliary display device 602. In another embodiment, a fourth display connectivity manager 608 is implemented in the auxiliary display device's wirelessly connected wireless modem 606.

In various embodiments, the operational status and display connectivity capabilities of the primary display device 612 are determined. A wireless connection is then established between the primary display device 612 and the wireless network 138. In these and other embodiments, one of the display connectivity managers 616, 618 are selected to perform auxiliary display device autodetection operations to detect the presence and availability of the auxiliary display device 602. In one embodiment, the primary display device 612 is operating in a full power state and the first display connectivity manager 620 is used to perform the auxiliary display device autodetection operations. In another embodiment, the primary display device 612 is operating in an off or low power state and the second display connectivity manager 618 is used to perform the auxiliary display device autodetection operations. In yet another embodiment, the presence and availability of the auxiliary display device 602 is known and auxiliary display device autodetection operations are not required.

In different embodiments, one of the display connectivity managers 616, 618 is selected to establish a connection between the intelligent wireless modem 614 and the intelligent wireless modem 606 wirelessly connected to the auxiliary display device 602. Once the connection is established, the selected display connectivity manager 616, 618 collects information about the available auxiliary display device 602 from its corresponding third or fourth display connectivity manager 608, 610. Once information about the auxiliary display device 602 is collected, a determination is made whether display 604 of the available auxiliary display device 602 is supported by either the first or second display connectivity manager 618, 620. In one embodiment, support for the display 604 of auxiliary display device 602 is determined by the implementation of the display connectivity manager 620 on the primary display device 612. In another embodiment, support for the available auxiliary display device 602 is determined by the implementation of the display connectivity manager 618 on the intelligent wireless modem 616 coupled to the primary display device 612.

If it is determined that the auxiliary display device 602 is supported, then predetermined display control information is exchanged between either the first or second display connectivity managers 618, 620 and either the third or fourth display connectivity managers 608, 610. The exchanged display control information is then used to establish and maintain a session for the transmission of predetermined displayable information generated by the primary display device 612 for display on the display 604 of auxiliary display device 602. In one embodiment, a full auxiliary display output mode is activated when the primary display device 612 is operating in a full power state. In this mode, all displayable information generated by applications running on primary display device 612 is displayed on the display 604 of the auxiliary display device 602. In another embodiment, a predetermined subset of displayable information generated by applications running on primary display device 612 is selectively displayed on the display 604 of the auxiliary display device 602. In yet another embodiment, a subset auxiliary display output mode is activated when the primary display device 612 is in a low or off power state. In this mode, a predetermined subset of displayable information generated by gadget applications running on the intelligent wireless modem 616 connected to the primary display device 612 is displayed on the display 604 of the auxiliary display device 602.

FIG. 7 is a simplified block diagram illustrating an auxiliary display device 702 comprising a physically coupled wireless modem 706 as implemented in accordance with an embodiment of the invention. In this embodiment, a primary display device 612, such as a laptop computer, comprises a first display 614 and a first intelligent wireless modem 616. In one embodiment, a first display connectivity manager 620 is implemented in the primary display device 612. In another embodiment, a second display connectivity manager 618 is implemented in the intelligent wireless modem 616. An auxiliary display device 702, such as a stand-alone flat screen monitor, comprises a second display 704 and a second intelligent wireless modem 706, which is physically coupled. In one embodiment, the physical coupling is through a cable 742, such as a universal serial bus (USB) cable or a high definition multimedia interface (HDMI) cable, which couples the intelligent wireless modem 708 to a port 744. In another embodiment, the physical coupling is through a dock 740 that is physically integrated with auxiliary display device 702. In one embodiment, a third display connectivity manager 708 is implemented in the auxiliary display device's physically coupled, intelligent wireless modem 706.

In various embodiments, the operational status and display connectivity capabilities of the primary display device 612 are determined. A wireless connection is then established between the primary display device 612 and the wireless network 138. In these and other embodiments, one of the display connectivity managers 616, 618 is selected to perform auxiliary display device autodetection operations to detect the presence and availability of the auxiliary display device 702. In one embodiment, the primary display device 612 is operating in a full power state and the first display connectivity manager 620 is used to perform the auxiliary display device autodetection operations. In another embodiment, the primary display device 610 is operating in an off or low power state and the second display connectivity manager 618 is used to perform the auxiliary display device autodetection operations. In yet another embodiment, the presence and availability of the auxiliary display device 702 is known and auxiliary display device autodetection operations are not required.

In different embodiments, one of the display connectivity managers 616, 618 is selected to establish a connection between the intelligent wireless modem 614 and the intelligent wireless modem 706 physically coupled to the auxiliary display device 702. Once the connection is established, the selected display connectivity manager 616, 618 collects information about the available auxiliary display device 702 from its corresponding third display connectivity manager 708. Once information about the auxiliary display device 702 is collected, a determination is made whether display 704 of the available auxiliary display device 702 is supported by either the first or second display connectivity manager 618, 620. In one embodiment, support for the display 704 of auxiliary display device 702 is determined by the implementation of the display connectivity manager 620 on the primary display device 612. In another embodiment, support for the available auxiliary display device 702 is determined by the implementation of the display connectivity manager 618 on the intelligent wireless modem 616 coupled to the primary display device 612.

If it is determined that the auxiliary display device 702 is supported, then predetermined display control information is exchanged between either the first or second display connectivity managers 618, 620 and the third display connectivity manager 708. The exchanged display control information is then used to establish and maintain a session for the transmission of predetermined displayable information generated by the primary display device 612 for display on the display 704 of auxiliary display device 702. In one embodiment, a full auxiliary display output mode is activated when the primary display device 612 is operating in a full power state. In this mode, all displayable information generated by applications running on primary display device 612 is displayed on the display 704 of the auxiliary display device 702. In another embodiment, a predetermined subset of displayable information generated by applications running on primary display device 612 is selectively displayed on the display 704 of the auxiliary display device 702. In yet another embodiment, a subset auxiliary display output mode is activated when the primary display device 612 is in a low or off power state. In this mode, a predetermined subset of displayable information generated by gadget applications running on the intelligent wireless modem 616 connected to the primary display device 612 is displayed on the display 704 of the auxiliary display device 702.

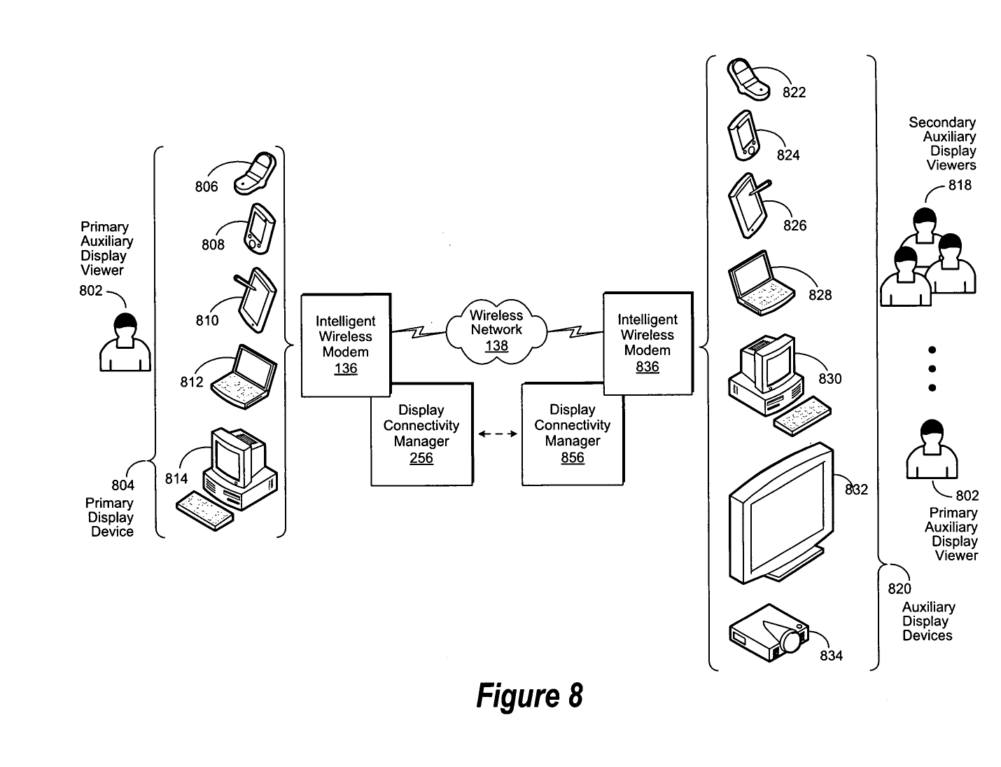

FIG. 8 is a simplified block diagram illustrating the wireless communication of displayable information from a primary display device 804 to a plurality of auxiliary display devices 820 in accordance with an embodiment of the invention. In various embodiments, a primary display device 804 comprises at least one display and an intelligent wireless modem 136, further comprising a display connectivity manager 256. Primary display devices 804 comprise, but are not limited to, a cell phone 806, a personal digital assistant (PDA) 808, a tablet personal computer (PC) 810, a laptop PC 812, and a stationary PC 814. Each primary display device 804 comprises an intelligent wireless modem 136, further comprising a display connectivity manager 256. In one embodiment, the display connectivity manager 256 is implemented in the primary display device 804. In another embodiment, the display connectivity manager 256 is implemented in the intelligent wireless modem 136.

In these and other embodiments, the operational status and display connectivity capabilities of the primary display device 804 are determined. A connection is then made to the wireless network 138 with the intelligent wireless modem 136. As described in greater detail herein, the wireless network 138 may comprise a wireless wide area network (WWAN), a wireless local area network (WLAN), a personal area network (PAN), or other combinations of wireless communication technologies. Once a wireless connection is established, the display connectivity manager 256 performs auxiliary display device autodetection operations to determine whether one or more auxiliary display devices 820 are available for wireless connectivity. Auxiliary display devices 820 comprise, but are not limited to, a cell phone 822, a PDA 824, a tablet PC 826, a laptop PC 828, a stationary PC 830, a flat screen monitor 832, and a liquid crystal diode (LCD) projector 834. Each auxiliary display device 820 comprises at least one display and an intelligent wireless modem 836, further comprising a display connectivity manager 856. In one embodiment, the display connectivity manager 856 is implemented in the auxiliary display devices 820. In another embodiment, the display connectivity manager 856 is implemented in the intelligent wireless modem 836. A wireless connection is then established between the primary display device and any detected auxiliary display devices. In one embodiment, the presence and availability of one or more auxiliary display devices 820 is known in advance and a wireless connection is manually established between intelligent wireless modem 136 and intelligent wireless modem 836.

Information about each of the detected or known auxiliary display devices 820 is then collected from their respective auxiliary device connectivity managers 856 by the display connectivity manager 256 of the primary display device 804. Once information about the one or more available auxiliary display devices 820 is collected, a determination is made whether they are supported by the primary display device 804. In one embodiment, support for an available auxiliary display device is determined by the implementation of the display connectivity manager 256 on the primary display device 804. In another embodiment, support for an available auxiliary display device is determined by the implementation of the display connectivity manager 256 on the intelligent wireless modem 136 coupled to the primary display device 804. A wireless connection is then made between the primary display device 804 and the one or more available auxiliary display devices 820 that are determined to be supported by the display connectivity manager 256.

Monitoring operations are then begun to monitor the power state of the primary display device 804. A determination is then made whether the primary display device 804 is operating in a full, low or off power state. If it is operating in a full power state, then a full auxiliary display output mode is activated by the display connectivity manager 256. The primary auxiliary display user 802 then decides whether to display all of, or a subset of, the displayable information output generated by the primary display device 804 on the selected one or more auxiliary display devices 820. The displayable information output generated by the primary display device 804 is then displayed on the selected one or more auxiliary display devices 820.

However, if the primary display device is operating in a low or off power state, then a subset auxiliary display output mode is activated by the display connectivity manager 256. Once the subset auxiliary display output mode is activated, a predetermined subset of displayable information generated by the primary display device 804 is then displayed on the selected one or more auxiliary display devices 820. In one embodiment, a predetermined subset of displayable information generated by applications running on the primary display device 804 is displayed on the selected one or more auxiliary display devices 820. In another embodiment, a predetermined subset of displayable information generated by gadget applications running on the intelligent wireless modem 136 connected to the primary display device 804 is displayed on the selected one or more auxiliary display devices 820.

It will be appreciated that the ability to selectively display the displayable information output of the primary display device 804 on one or more auxiliary display devices 820 provides flexibility in how the displayed content is viewed by secondary auxiliary display viewers 818 as well. As an example, a primary display device 804, such as a laptop computer 812, may be operated by a primary auxiliary display viewer 802 in a venue that comprises one or more LCD projectors, viewable by the secondary auxiliary display viewers 818. Some of the auxiliary display viewers 818 may also have access to other auxiliary devices 820, such as their own laptop computers 828. In this example, the display connectivity manager 256 establishes a connection to wireless network 138 and autodetects all auxiliary display devices 820 that are present and available to receive display output from the primary display device 804. Display device information is collected from the display connectivity manager 856 of each of the auxiliary display devices 820. Wireless auxiliary display device connections are then established between the primary display device 804 and the auxiliary display devices 820 that are supported by the display connectivity manager 256. The supported auxiliary display devices 820 then receive all of, or a subset of, the displayable information output generated by the primary display device 804.

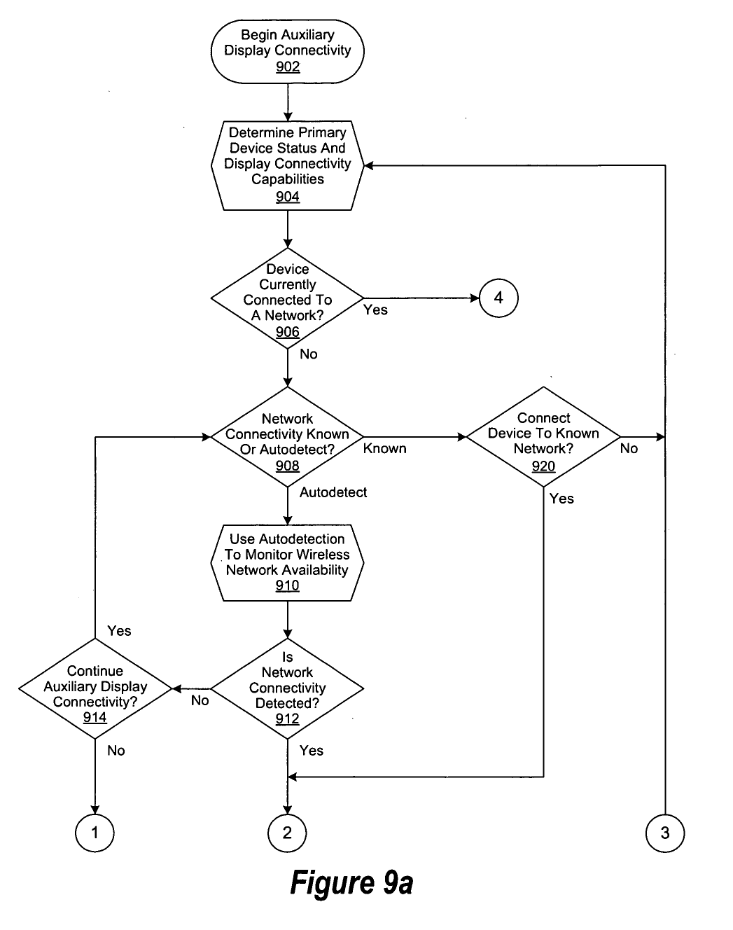

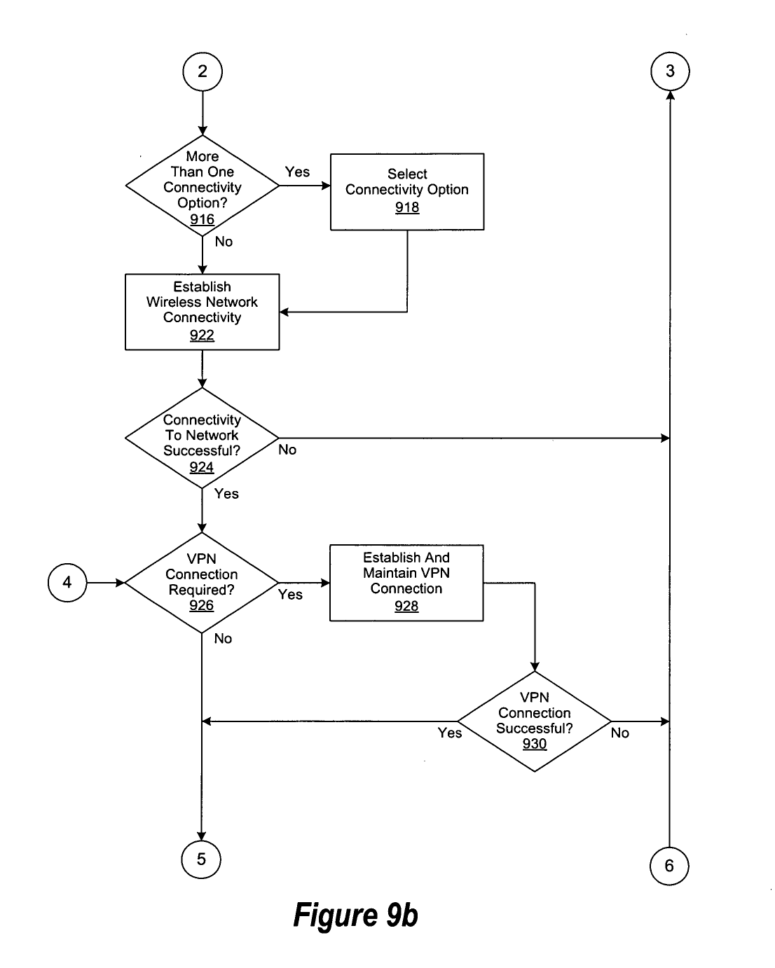

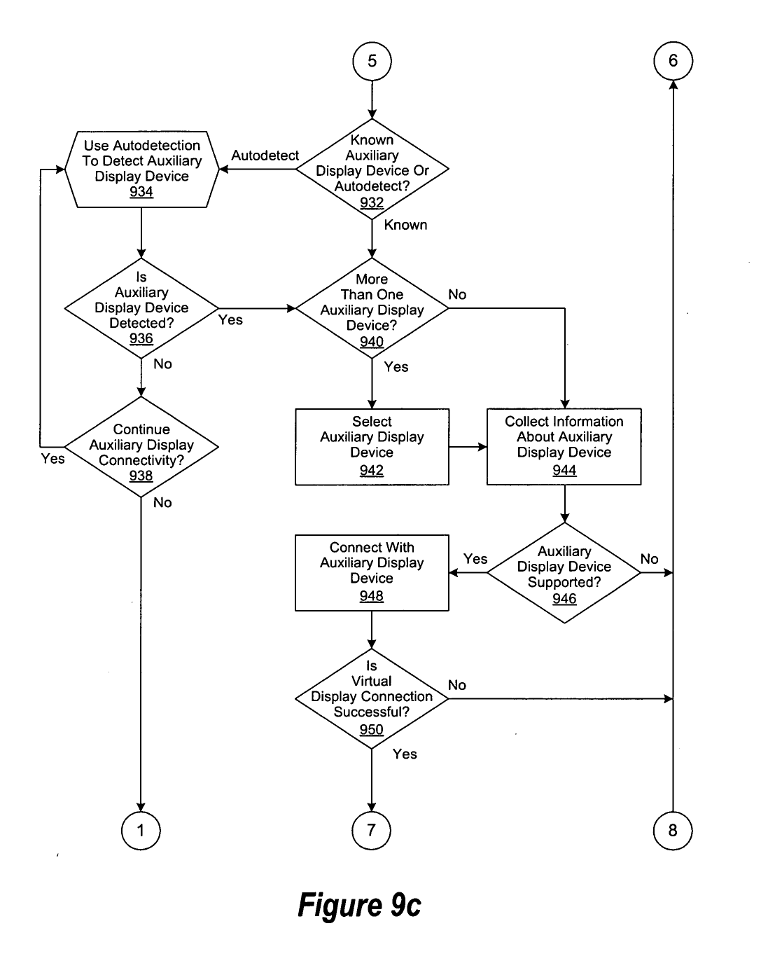

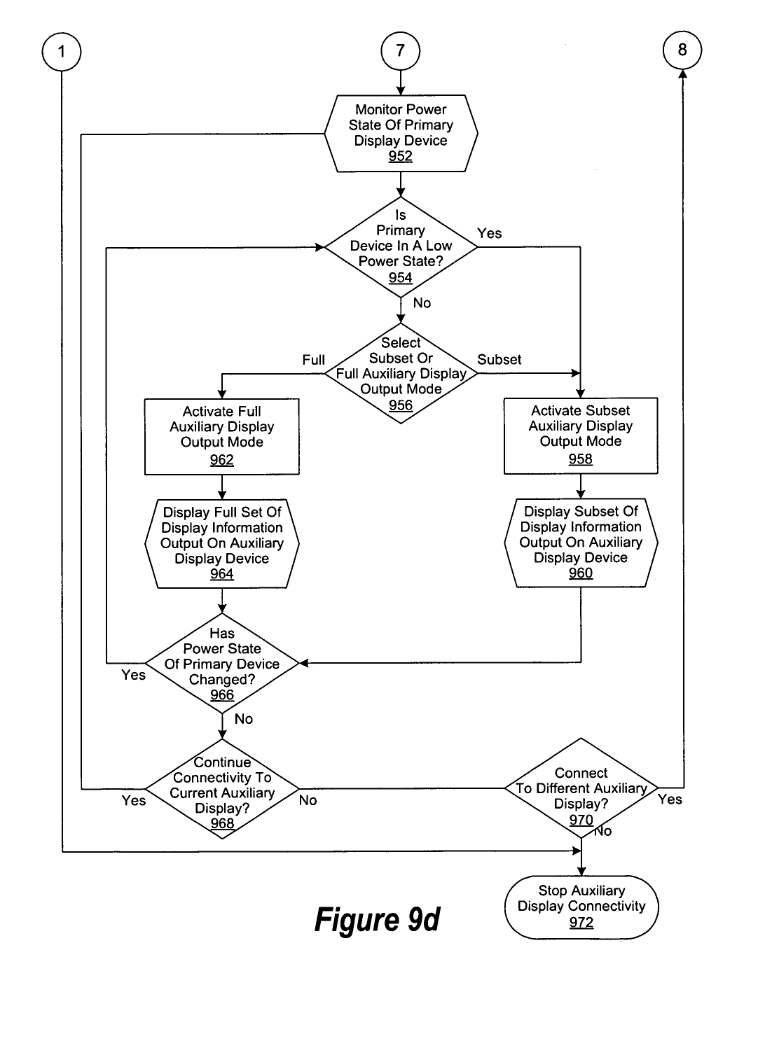

FIG. 9 is a generalized flowchart of a display connectivity manager as implemented in accordance with an embodiment of the invention. In this embodiment, auxiliary display connectivity operations for a primary device comprising one or more displays, a wireless modem, and a display connectivity manager begin in step 902. In step 904, the operational status and display connectivity capabilities of the primary display device are determined. A determination is then made in step 906 whether the primary display device is currently connected to a wireless network. If it is determined that the primary device is not connected to a network, then a determination is made in step 908 whether known wireless network connectivity is available or if wireless network autodetection operations are to be performed. If it is determined in step 908 to perform wireless network autodetection operations, then they are performed in step 910 to monitor the availability of wireless connectivity. If it is determined in step 912 that wireless connectivity is not detected, then a determination is made in step 914 whether to continue auxiliary display connectivity operations. If a determination is made to cease auxiliary display connectivity operations, then they are discontinued in step 972. Otherwise, the process is repeated, beginning with step 908.

However, if it is determined in step 908 that known wireless network connectivity is available, then a determination is made in step 920 to connect the primary device to the known wireless network connectivity. If it is decided to not connect the primary display device to the known network connectivity, then the process is repeated, beginning with step 904. If wireless network connectivity is detected in step 912, or if it is decided to connect the primary display device to the known network connectivity in step 920, then a determination is made in step 916 whether more than one wireless connectivity option is available. As an example, a mobile device user may be in a venue where both wireless wide area network (WWAN) and wireless local area network (WLAN) connectivity is available. As a result, the user has a choice of wireless connectivity options if their mobile device is implemented with an intelligent wireless modem that supports connectivity to either the WWAN or the WLAN. It will be appreciated that these connectivity options often present trade-offs. For example, connectivity to an EDGE WWAN may offer broader network coverage but limited bandwidth. Conversely, connectivity to an 802.11 WLAN may provide higher bandwidth at the expense of limited network coverage. If it is determined in step 916 that more than one wireless connectivity option is available, then the wireless connectivity option is selected in step 918. Once the wireless connectivity option is selected in step 918, or if it is determined in step 916 that more than one wireless connectivity option is not available, then wireless network connectivity is established in step 922.

A determination is then made in step 924 whether wireless connectivity was successful. If it was not, then the process is repeated, beginning with step 904. If it is determined in step 924 that wireless connectivity was successful, or if it is determined in step 906 that the primary display device is currently connected to a wireless network, then a determination is made in step 926 whether a virtual private network (VPN) connection is required. If so, then VPN operations are performed in step 928 to establish and maintain a VPN connection. A determination is then made in step 930 whether the VPN connection was successfully established and maintained. If it has not, then the process is repeated, beginning with step 904. If it has, or if it is determined in step 926 that a VPN connection is not required, then a determination is made in step 932 whether a known auxiliary display device is available or if auxiliary display device autodetection operations are to be performed. If it is determined in step 932 to perform auxiliary display device autodetection operations, then they are performed in step 934. A determination is then made in step 936 whether an auxiliary display device has been detected. If not, a determination is made in step 938 whether to continue auxiliary display connectivity operations. If it is decided in step 938 to continue auxiliary display connectivity operations, then they are continued, beginning with step 934. Otherwise, auxiliary display connectivity operations are discontinued in step 972.

However, if it is determined in step 936 that an auxiliary display device has been detected, or if is determined in step 932 that a known auxiliary display device is available, then a determination is made in step 940 whether more than one auxiliary display device is available. If it is determined in step 940 that more than one auxiliary display device is available, then one or more available auxiliary display devices are selected in step 942. Once the available auxiliary display devices are selected in step 942, or if it is determined in step 940 that only one auxiliary display device is available, then information about the available auxiliary display device is collected in step 944.

Once information about the available auxiliary display devices is collected in step 944, a determination is made in step 946 whether the selected auxiliary display devices are supported. In one embodiment, support for the selected auxiliary display devices is determined by the implementation of a display connectivity manager on the primary display device. In another embodiment, support for the selected auxiliary display devices is determined by the implementation of a display connectivity manager on an intelligent wireless modem coupled to the primary display device. If it is determined in step 946 that the selected display devices are not supported by the display connectivity manager, then the process is repeated, beginning with step 904. Otherwise, a wireless connection is made between the primary display device and the supported auxiliary display devices in step 948. A determination is then made in step 950 whether the wireless connection to the supported auxiliary display device is successful. If it is not, then the process is repeated, beginning with step 904.

Otherwise, monitoring operations are begun in step 952 to monitor the power state of the primary display device. A determination is then made in step 954 whether the primary display device is operating in a low or off power state. If it is not, then a determination is made in step 956 whether to display the full displayable information output generated by the primary display device, or a subset thereof, on the auxiliary display device. If it is determined in step 956 to display a subset of displayable information on the auxiliary display device, or if it is determined in step 954 that the primary display device is in a low or off power state, then a subset auxiliary display output mode is activated in step 958. Once the subset auxiliary display output mode is activated, a predetermined subset of displayable information is displayed on the auxiliary display device in step 960. In one embodiment, a predetermined subset of displayable information generated by applications running on the primary display device is displayed on the auxiliary display device. In another embodiment, a predetermined subset of displayable information generated by gadget applications running on an intelligent wireless modem connected to the primary display device is displayed on the auxiliary display device.

However, if it is determined in step 956 to display the full set of displayable information on the auxiliary display device, then a full auxiliary display output mode is activated in step 962. The full display output generated by the primary display device is then displayed on the auxiliary display device in step 964. Regardless of the auxiliary display output mode selected in step 956, a determination is made in step 966 whether the power state of the primary display device has changed. If it has, then the process is repeated, beginning with step 954. If it has not, a determination is made in step 968 whether to continue connectivity operations with the current auxiliary display device. If it is determined in step 968 to continue connectivity operations with the current auxiliary display device, then the process is repeated, beginning with step 952. Otherwise, a determination is made in step 970 whether to wirelessly connect the primary display device to a different auxiliary display device. If so, the process is repeated, beginning with step 904. Otherwise, auxiliary display connectivity operations are ended in step 972.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for wirelessly communicating displayable information, comprising:
a first device comprising a first display, wherein said first device is operable to generate and wirelessly transmit displayable information;
a first display connectivity manager operable to manage transmission of said displayable information and its display on said first display;
a second device comprising a second display, wherein said second device is operable to wirelessly receive and display said displayable information;
a second display connectivity manager operable to manage said wireless reception of displayable information and its said display on said second display; and
processing logic operable to establish wireless connectivity to communicate said displayable information between said first device and said second device.

2. The system of claim 1, wherein said first device further comprises a first wireless modem and said second device comprises a second wireless modem.

3. The system of claim 2, wherein said first wireless modem is operable to be physically coupled to said first device and said second wireless modem is operable to be physically coupled to said second device.

4. The system of claim 3, wherein said physical coupling is through a cable, said cable comprising a plurality of interface connections.

5. The system of claim 3, wherein said physical coupling is through a dock, said dock comprising a plurality of interface connections.

6. The system of claim 2, wherein said first and second wireless modems comprise a processor and memory operable to execute said processing logic to establish said wireless network connectivity.

7. The system of claim 6, wherein said wireless network connectivity is established using a wireless wide area network (WWAN).

8. The system of claim 6, wherein said wireless network connectivity is established using a wireless local area network (WLAN).

9. The system of claim 6, wherein said wireless network connectivity is established using a personal area network (PAN).

10. The system of claim 2, wherein said first display connectivity manager is operable to operate in said first wireless modem and said second display connectivity manager is operable to operate in said second wireless modem.

11. A method for wirelessly communicating displayable information, comprising:
wirelessly transmitting displayable information generated by a first device comprising a first display;
managing said wireless transmission of displayable information and its display on said first display with a first display connectivity manager;
wirelessly receiving said displayable information for display on second device comprising a second display;
managing said wireless receipt of said displayable information and its said display on said second display with a second display connectivity manager; and
using processing logic operable to establish wireless connectivity to communicate said displayable information between said first device and said second device.

12. The method of claim 11, wherein said first device further comprises a first wireless modem and said second device comprises a second wireless modem.

13. The method of claim 12, wherein said first wireless modem is operable to be physically coupled to said first device and said second wireless modem is operable to be physically coupled to said second device.

14. The method of claim 13, wherein said physical coupling is through a cable, said cable comprising a plurality of interface connections.

15. The method of claim 11, wherein said physical coupling is through a dock, said dock comprising a plurality of interface connections.

16. The method of claim 12, wherein said first and second wireless modems comprise a processor and memory operable to execute said processing logic to establish said wireless network connectivity.

17. The method of claim 16, wherein said wireless network connectivity is established using a wireless wide area network (WWAN).

18. The method of claim 16, wherein said wireless network connectivity is established using a wireless local area network (WLAN).

19. The method of claim 16, wherein said wireless network connectivity is established using a personal area network (PAN).

20. The method of claim 12, wherein said first display connectivity manager is operable to operate in said first wireless modem and said second display connectivity manager is operable to operate in said second wireless modem.
